(19) United States
(12) Patent Application Publication
(10) Pub. No.: US 2018/0154536 A1
(43) Pub. Date: Jun. 7, 2018

(54) DEVICE FOR THE COMMINUTION OF FOODSTUFFS

(71) Applicant: Genius GmbH, Limburg (DE)

(72) Inventor: Cedomir REPAC, Brechen (DE)

(21) Appl. No.: 15/828,475

(22) Filed: Dec. 1, 2017

(30) Foreign Application Priority Data
Dec. 1, 2016 (LU) 93329
Dec. 1, 2016 (LU) 93330

(51) Int. Cl. B26D 3/24; B26D 5/10; B26D 7/06; B26B 27/00; B26D 3/18

(52) U.S. Cl. CPC B26D 3/24; B26D 5/10; B26D 7/0608; B26D 2007/0018; B26D 3/185; B26D 2210/02; B26B 27/00

(57) ABSTRACT

The invention relates to a device for comminuting foodstuffs, having a base part which has a receptacle for a cutting part, and having an actuation part that is connected in an articulated manner to the base part and is pivotable toward the base part in order for a product to be comminuted to be pushed along a pushing through direction through a cutting part that is inserted into the receptacle. The device is distinguished in that a plurality of cutting parts are present and in that the receptacle is configured for receiving at least two cutting parts on top of one another such that product to be comminuted by means of a pivoting movement of the actuation part toward the base part is capable of being pushed through the cutting parts that are disposed on top of one another in the receptacle wherein the two cutting parts are disposable at different mutual relative rotary alignments in the receptacle.

### CROSS-REFERENCE TO RELATED APPLICATIONS

The present application claims priority of Luxembourgian Patent Application No. LU93329 filed Dec. 5, 2017 and Luxembourgian Patent Application No. LU93330 filed Dec. 5, 2017, the entire disclosures of which are incorporated herein by reference.

### FIELD OF THE INVENTION

The invention relates to a device for comminuting foodstuffs, having a base part which has a receptacle for a cutting part, and having an actuation part that is connected in an articulated manner to the base part and is pivotable toward the base part in order for a product to be comminuted to be pushed along a pushing through direction through a cutting part that is inserted into the receptacle.

### BACKGROUND OF THE INVENTION

A hand-held apparatus which has two handgrip parts is known from DE 10 2007 042 660 A1. A press plunger is disposed on one handgrip part, and a cutting part is disposed on the other handgrip part. The cutting part has a cutting blade assembly by way of which the foodstuffs product can be cut into strips. However, in the preparation of foodstuffs it is often necessary for foodstuffs also to be cut into shapes other than strips. Other foodstuff comminution devices have to be used in order for this to be achieved. Similar apparatuses are known from US 2014/0190019 A1 and from EP 1 874 508 B1.

### SUMMARY OF THE INVENTION

It is the object of the present invention to specify a device for commuting foodstuffs which permits foodstuff products to be comminuted in a diverse manner into different cut shapes.

The object is achieved by a device of the type mentioned at the outset which is characterized in that a plurality of cutting parts are present and in that the receptacle is configured for receiving at least two cutting parts on top of one another such that product to be comminuted by means of a pivoting movement of the actuation part toward the base part is capable of being pushed through the cutting parts that are disposed on top of one another in the receptacle, wherein the two cutting parts are disposable at different mutual relative rotary alignments in the receptacle.

The invention has the very particular advantage that a comminution of foodstuffs into very different cut shapes is enabled in a diverse manner without the same number of different cutting parts as there are potential cut shapes having to be present. The present invention far rather enables a comminution into different cut shapes by the combination of different cutting parts and/or by the selection of different rotary alignments of cutting parts. For example, as will be explained in more detail hereunder, it is possible for the same two cutting parts to be disposed in a first mutual relative rotary alignment in the receptacle so as to cut slices, or alternatively to be disposed in a second mutual relative rotary alignment in the receptacle so as to cut sticks which are diamond-shaped in the cross section, for example. It is also possible for the same two cutting parts to be disposed in a third mutual relative rotary alignment in the receptacle, so as to cut sticks or cubes that are square or rectangular in the cross-section, for example.

On account of the invention there is no longer any requirement for different foodstuff comminution devices to be used for different cut shapes.

However, according to an independent aspect of the invention, in particular in combination with one of the particular press plungers described further below, it is also possible for different cut shapes to be cut exclusively in a simple manner by combining different cutting parts in the receptacle. It is particularly advantageous herein for one and the same press plunger to be configured to be used for different combinations of cutting parts that are disposed in the receptacle.

In the case of an advantageous embodiment the cutting parts are stackable on top of one another in such a manner that the cutting planes of the cutting blades of the stacked cutting parts are disposed so as to be mutually parallel. Alternatively or additionally, it can advantageously be provided that the cutting parts are stackable on top of one another in such a manner that the cutting planes of the cutting blades of the stacked cutting parts are disposed so as to be mutually spaced apart. These embodiments are particularly advantageous in order for different mutually relative rotary alignments of the cutting parts to be enabled in the receptacle.

In the case of a very particularly advantageous embodiment the cutting parts are stackable on top of one another in such a manner that the cutting parts in terms of their mutual relative alignment, in particular in terms of their mutual rotary alignment, are fixed in a plane that is perpendicular to the pushing through direction. Such an embodiment guarantees that the cutting parts do not move in a mutually relative manner in a comminution procedure. A relative movement of the cutting parts would be disadvantageous in particular because there is then the risk of the cutting blades of the cutting parts not plunging into the grooves of the press plunger that are provided for this purpose. The particular embodiment mentioned to this extent contributes toward preventing the press plunger being damaged by the cutting blades in a comminution procedure.

In the case of an advantageous embodiment which enables a flexible combination of the arrangement and of the relative rotary alignment of cutting parts in the receptacle, the cutting parts have identical external dimensions. Alternatively, it can advantageously be provided at least that the cutting parts in a plane that is perpendicular to the pushing through direction have identical external dimensions.

In particular in order for cutting parts that are disposed on top of one another in the receptacle to be fixed in a mutually relative manner, it can be advantageously provided that at least one cutting part has a coupling means which is configured and specified for being operatively connected, in particular in a form-fitting manner, to a counter-coupling means of another cutting part. In particular it is also possible for at least one cutting part to have both a coupling means which is configured and specified for being operatively connected, in particular in a form-fitting manner, to a counter-coupling means of another cutting part, as well as a counter-coupling means which is configured and specified for being operatively connected to a coupling means of another cutting part.

The coupling means can advantageously be configured as a toothing or have a toothing. The toothing can have teeth with a rounded tooth tip and/or a rounded tooth root. It can be provided in an analogous manner that the counter-coupling means is configured as a counter-toothing or has a counter-toothing. The counter-toothing can also have teeth with a rounded tooth tip and/or a rounded tooth root.

An embodiment in which the cutting parts in each case have one blade holder to which at least one cutting blade is fastened in particular so as not to be releasable in a non-destructive manner is particularly robust and easy to handle.

The blade holder can in particular comprise the coupling means and/or the counter-coupling means. In a particular embodiment which permits simple and reliable coupling of the cutting parts that are inserted on top of one another in the receptacle, the blade holder as the coupling means has a toothing that is aligned counter to the pushing through direction. Alternatively or additionally, the blade holder as the counter-coupling means can have a counter-toothing that is aligned in the pushing through direction.

The blade holder can be configured in particular as a frame which in a cutting-blade plane of the cutting part surrounds at least one cutting blade, in particular a plurality of cutting blades that are disposed in a cutting-blade arrangement. In particular, an end side of the frame can have the toothing or the counter-toothing.

It is particularly advantageous for the blade holders of the cutting parts to be of identical configuration, or for the blade holders of the cutting parts to have identical dimensions in the cutting plane and/or in a plane that is perpendicular to the pushing through direction. Such an embodiment advantageously enables a plurality of cutting parts in different combinations and/or relative rotary alignments to be disposed in the receptacle.

In the case of a particular embodiment the blade holders are configured so as to be square. Such an embodiment enables cutting parts to be disposed in the receptacle with an exact fit in a first rotary alignment and in a rotary alignment that is rotated by 90 degrees. In very general terms, it can advantageously be provided that the cutting parts comprise a rotational symmetry.

In the case of a very particularly advantageous embodiment it is provided that two cutting parts are disposable in the receptacle so as to selectively have at least a first mutual relative rotary alignment or so as to have a second mutual relative rotary alignment, wherein the first rotary alignment differs from the second rotary alignment by a rotation angle of 45 degrees or of 90 degrees. However, other angles are also possible.

At least two of the cutting parts preferably have different cutting-blade arrangements. However, it is also possible for two of the cutting parts to have identical cutting-blade arrangements, wherein different cut shapes are nevertheless implementable by different mutual relative rotary alignments of the cutting parts.

In the case of a particularly advantageous embodiment a first cutting part has mutually parallel first cutting blades, while a second cutting part likewise has mutually parallel second cutting blades. It is possible herein for the first cutting part and the second cutting part to be disposed on top of one another in the receptacle in such a manner that the first cutting blades and the second cutting blades are disposed so as to be mutually parallel. In particular, it can be advantageously provided that the first cutting part and the second cutting part are disposable on top of one another in the receptacle in such a manner that the first cutting blades and the second cutting blades are disposed so as to be mutually parallel but so as to be mutually offset in a projection along the pushing through direction. Such an arrangement serves in particular for cutting slices.

In order for another cut shape to be implemented, the first cutting part and the second cutting part can be disposed on top of one another in the receptacle in such a manner that the first cutting blades and the second cutting blades in a projection along the pushing through direction are disposed in a mutually cruciform manner and/or in a projection along the pushing through direction are mutually orthogonal. Such an arrangement serves in particular for cutting sticks or cubes.

The actuation part preferably has a press plunger, wherein it can be advantageously provided in particular that the press plunger has grooves into which the cutting blades of the cutting parts that are inserted into the receptacle plunge in a comminution procedure.

In the case of an advantageous embodiment that is in particular easy to operate, the press plunger is disposed on a press lever of the actuation part so as to be non-releasable, in particular not releasable in a non-destructive manner. The press plunger can be connected to a press lever of the actuation part by means of a materially integral connection, for example. Alternatively, the press plunger and the press lever can be conjointly produced in an integral manner. A non-releasable connection between the press plunger and the press lever has the advantage that the press plunger cannot be lost in the use of the device. It can be provided in particular herein that the press plunger has a multiplicity of different grooves and/or sets of grooves such that the press plunger can be used for pushing a foodstuff product by way of cutting parts that are disposed on top of one another in different combinations and/or rotary alignments in the receptacle.

In the case of another embodiment the press plunger is secured or is securable on a press lever of the actuation part so as to be releasable, in particular so as to be releasable in a non-destructive manner and/or without tools. However, it can also be provided in the case of such an embodiment that the press plunger has a multiplicity of different grooves and/or sets of grooves such that the press plunger can be used for pushing a foodstuff product by way of cutting parts that are disposed on top of one another in different combinations and/or rotary alignments in the receptacle.

However, it is also possible for a plurality of different press plungers to be present for pushing a foodstuff product by way of cutting parts that are disposed on top of one another in different combinations and/or rotary alignments in the receptacle, the matching press plunger for the presently selected combination and/or rotary alignment of cutting parts that are disposed on top of one another in the receptacle being selected from said plurality of different press plungers and being disposed on the press lever.

In the case of a very particularly advantageous embodiment the press plunger is configured as a double press plunger which has two, in particular different, individual press plungers and which is secured or securable selectively in a first operative position or in a second operative position on a press lever of the actuation part. It can be provided in the case of such an embodiment that one or both individual press plungers has/have a multiplicity of different grooves and/or sets of grooves such that the individual press plunger can be used for pushing a foodstuff product by way of cutting parts that are disposed on top of one another in the receptacle in different combinations and/or rotary alignments. However, it is also possible for one or both individual press plungers to be configured for pushing a foodstuff product by way of a very specific cutting part, or by way of a very specific combination of cutting parts, or by way of a very specific combination of cutting parts in a specific rotary alignment.

The double press plunger can advantageously be configured in particular in such a manner that said double press plunger is transferable from the first operative position to the second operative position by rotating, in particular by way of a rotation by 180 degrees. It can be advantageously provided in particular that the double press plunger can be secured on a press lever selectively in the first operative position or in the second operative position.

As has already been mentioned, it can in very general terms be provided that the same press plunger is configured to be used with different cutting parts that are inserted into the receptacle, and/or that the same press plunger is configured to be used with different combinations of cutting parts that are inserted into the receptacle, (in particular also in the case of different mutual rotary alignments of the cutting parts). Alternatively or additionally, it can advantageously be provided in particular that one and the same press plunger is configured to be used with a plurality of cutting parts that are disposed on top of one another in the receptacle, independently of the mutual rotary alignment of the cutting parts that are disposed on top of one another in the receptacle.

In the case of a very particularly advantageous embodiment the press plunger includes a set of grooves which has at least two grooves that run mutually parallel and another set of grooves comprising a first other groove, wherein the first other groove intersects the at least two grooves in each case at an angle that is more than 0 degrees and less than 90 degrees (right angle). Such a press plunger in particular can be disposed on a press lever of the actuation part so as to be non-releasable, in particular not releasable in a non-destructive manner because such a press plunger in particular can be advantageously used for pushing a foodstuff product by way of cutting parts that are disposed on top of one another in the receptacle in different combinations and/or rotary alignments. However, it is also possible for such a press plunger to be securable on a press lever so as to be releasable.

Such a press plunger has the advantage that the same press plunger can be brought to engage with a plurality of cutting parts having different cutting-blade arrangements and/or different mutually relative rotary alignments. This means that different cut shapes for the cut foodstuff product can be implemented by means of the same device for comminuting foodstuffs, without the press plunger having to be replaced.

Moreover, such a press plunger enables the use of cutting parts or combinations of cutting parts having cutting-blade arrangements which if at all have been able to be used only in a cumbersome manner to date. In particular, a cutting part or a combination of cutting parts which has two cutting blades that run so as to be mutually parallel and a further cutting blade which intersects the two cutting blades that run so as to be mutually parallel at an angle of more than 0° and less than 90° can be used.

A groove in the context of the invention is understood to be a depression in the press plunger. The groove serves for receiving a cutting blade of a cutting part in a comminution procedure.

In the case of a particular embodiment the other set of grooves of the particular press plunger can have a second other groove. The first other groove and the second other groove can mutually intersect in a crossing region. The first other groove and the second other groove can mutually intersect at an angle unequal to 90°. The second other groove can intersect the grooves of the set of grooves at an angle which in each case is more than 0° and less than 90°. In particular, the first other groove can intersect the at least two grooves at the same angle as the second other groove. Of course, the other set of grooves can also have additional grooves which intersect the aforementioned grooves in the crossing region. In particular, a groove of the set of grooves can intersect the first other groove and the second other groove in the crossing region.

In the case of a very particular embodiment the press plunger can have a further set of grooves which comprises at least two further grooves. The further grooves can run so as to be mutually parallel. Each of the further grooves of the further set of grooves herein can intersect the grooves of the set of grooves in each case at an angle of 90°. The first other groove and/or the second other groove of the other set of grooves intersect each of the further grooves at an angle of more than 0° and less than 90°. Moreover, a further groove of the further set of grooves can intersect the first other groove and the second other groove in the crossing region.

The press plunger can be brought to engage with a cutting part or a combination of cutting parts having one cutting-blade arrangement, and be brought to engage with another cutting part or another combination of cutting parts having another cutting-blade arrangement in which at least two, in particular precisely three, cutting blades mutually intersect in a crossing region. The cutting blades mutually intersect in each case at an angle of less than 90°.

The cutting part or a combination of cutting parts can have a cutting-blade arrangement in which the cutting blades run so as to be mutually parallel. This cutting-blade arrangement enables the cutting of foodstuffs in slices. Comparatively thin slices can be implemented when two cutting parts having in each case cutting blades that run so as to be mutually parallel are disposed on top of one another in the receptacle, wherein the cutting blades in the projection are disposed so as to be mutually offset.

Alternatively, a cutting part or a combination of cutting parts can have a cutting-blade arrangement in which the cutting blades form a mesh-shaped pattern. This cutting-blade arrangement enables the cutting of foodstuffs in sticks or cubes. The mesh-shaped cutting pattern can be implemented in particular in that two cutting parts having in each case cutting blades that run so as to be mutually parallel are placed on top of one another, wherein one of the two cutting parts is rotated by 90° in relation to the other cutting part. The direction of the cutting blades of the upper cutting part preferably runs perpendicularly to the rotation axis about which the actuation part is pivotable relative to the base part, because the plunging of the press plunger is facilitated on account thereof and jamming of the press plunger is avoided in particular.

The further set of grooves of the particular press plunger can comprise at least one further groove, in particular a plurality of first further grooves, and at least one second further groove, in particular a plurality of second further grooves. The second further groove can have a groove depth that is dissimilar to the first further groove. The provision of grooves having different groove depth offers the advantage that the press plunger can be used both in the case of individual cutting parts as well as in the case of cutting parts that are placed on top of one another. The provision of grooves having different groove depth offers in particular the advantage that the press plunger in terms of the structure thereof is weakened by the grooves only to the extent required and to this extent is particularly stable. The other grooves of the other set of grooves can have the same groove depth and/or the grooves of the set of grooves can have the same groove depth.

In the case of one very particular embodiment the further grooves of the further set of grooves can extend from a first press-plunger peripheral side to a second press-plunger peripheral side. Moreover, the first other groove can extend from a third press-plunger peripheral side to a fourth press-plunger peripheral side. The same applies to the second other groove. The grooves of the set of grooves can extend from the third press-plunger peripheral side to the fourth press-plunger peripheral side.

The grooves of the set of grooves and/or the other grooves of the other set of grooves and/or the further grooves of the further set of grooves have a linear and/or uninterrupted profile. Moreover, the first other groove and the second other groove have a constant incline.

In the case of one particular embodiment at least one further press plunger which is securable as a replacement for the press plunger on the press lever is present. It can be provided in particular that a press plunger is configured to be used with a plurality of specific cutting parts that are disposed on top of one another in the receptacle, while the further press plunger is configured to be used with a plurality of other cutting parts that are disposed on top of one another in the receptacle. It is also possible for a press plunger to be configured to be used with a plurality of specific cutting parts that are disposed on top of one another in the receptacle and have a specific mutual rotary alignment, while the further press plunger is configured to be used with the same cutting parts that are disposed on top of one another in the receptacle when the latter have another mutual rotary alignment.

In very general terms and according to an independent aspect of the invention, a device for comminuting foodstuffs of the type mentioned at the outset in which the press plunger is attachable to a press lever of the actuation part so as to be releasable is particularly advantageous.

In the case of an advantageous embodiment the base part is placed or is placeable on a container for the comminuted product. It is also possible for the base part to have a container for the comminuted product. The latter preferably in such a manner that the comminuted foodstuff product automatically reaches the container when a comminution procedure is carried out.

The device according to the invention can advantageously be configured as a hand-held apparatus. It can be provided in particular herein that the base part has a first handgrip part and the actuation part has a second handgrip part, both handgrip parts being able to be collectively gripped with the fingers of one hand. In order for a comminution procedure to be carried out the handgrip parts can be mutually compressed in particular in the manner of pliers. The device according to the invention that is embodied as a hand-held apparatus can preferably be completely held by hand without being supported on a worktop when a comminution procedure is being carried out

In particular, an embodiment of the device that is embodied as a hand-held apparatus can have a container for the comminuted foodstuff product. In the case of a particularly readily manageable embodiment the first handgrip part protrudes laterally beyond the container.

Alternatively, the device can be advantageously configured as a table-top apparatus. Alternatively or additionally, the device for a comminution procedure can be configured and specified to be set up on a worktop. It is also possible for the device to have a stand for setting up on a worktop. In the case of a particularly compact embodiment the stand is formed by a container for the comminuted product

### BRIEF DESCRIPTION OF THE DRAWING VIEWS

The subject matter of the invention is schematically illustrated in an exemplary manner in the drawing and will be described hereunder by means of the figures wherein identical elements or functionally equivalent elements even in different exemplary embodiments are in most instances provided with the same reference signs. In the drawing:

FIGS. 1 to 3 show schematic detailed views of an exemplary embodiment of a device according to the invention;

FIGS. 4 to 7 show a further exemplary embodiment of a device according to the invention in different configurations for cutting different cut shapes;

FIGS. 8 to 11 show an exemplary embodiment of an advantageous press plunger for a device according to the invention;

FIGS. 12 to 20 show another exemplary embodiment of a device according to the invention in different configurations for cutting different cut shapes; and

FIG. 21 shows an exemplary embodiment of a device according to the invention that is embodied as a table-top apparatus.

### DETAILED DESCRIPTION OF THE INVENTION

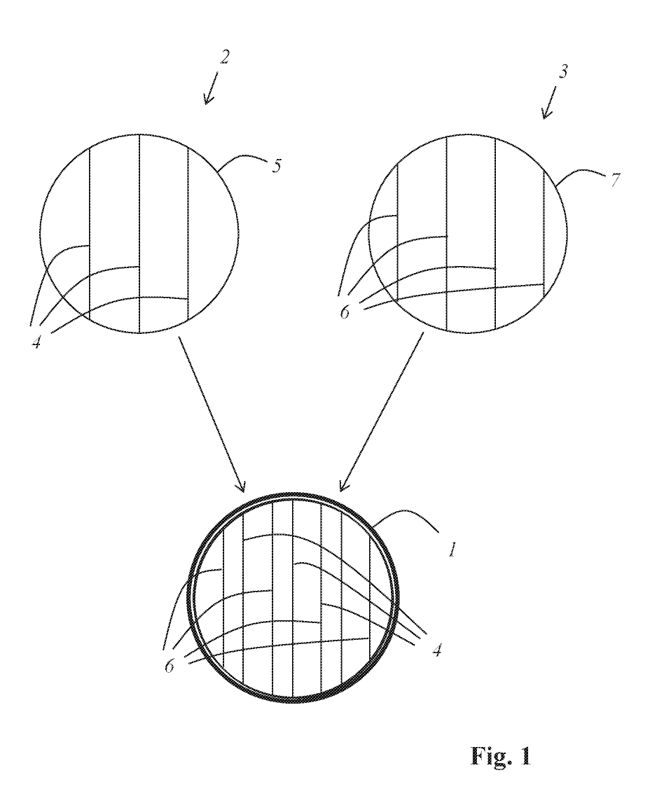

FIGS. 1 to 3 schematically and in the plan view show in an exemplary manner a receptacle 1 of a device according to the invention for comminuting foodstuffs. The receptacle 1 is configured for receiving at least two cutting parts 2, 3 on top of one another such that product to be comminuted by means of a pivoting movement of the actuation part toward the base part is advanceable through the cutting parts 2, 3 that are disposed on top of one another in the receptacle 1, wherein the two cutting parts 2, 3 are disposable in the receptacle 1 at different mutual relative rotary alignments.

A first cutting part 2 of the cutting parts 2, 3 has mutually parallel first cutting blades 4 which are disposed in a first frame 5 and are fixedly connected to the frame 5. A second cutting part 3 of the cutting parts 2, 3 has mutually parallel second cutting blades 6 which are disposed in a second frame 7 and are fixedly connected to the frame 7.

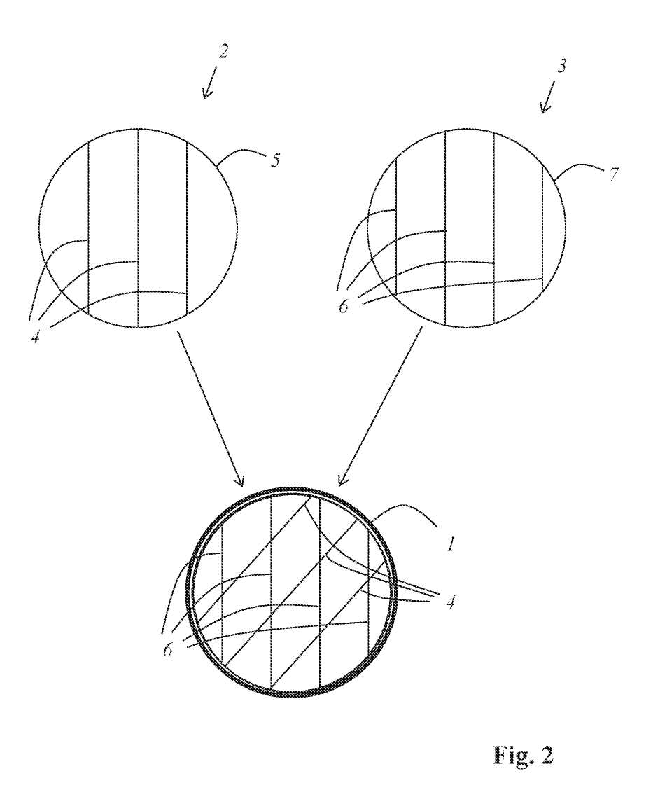

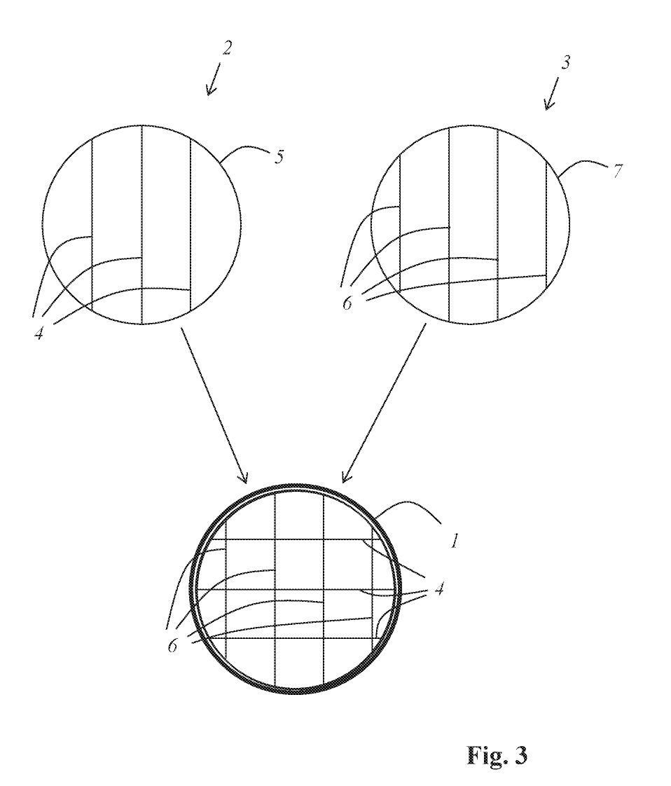

For example, it is possible for the two cutting parts 2, 3 to be disposed in a first mutual relative rotary alignment in the receptacle 1 in order for slices to be cut, this being illustrated in FIG. 1. Alternatively, it is possible for the two cutting parts 2, 3 to be disposed at a second mutual relative rotary alignment in the receptacle 1 in order for sticks that are diamond-shaped in the cross-section to be cut, this being illustrated in FIG. 2. Moreover, it is possible for the two cutting parts 2, 3 to be disposed at a third mutual relative rotary alignment in the receptacle 1 in order for sticks that are square or rectangular in the cross-section, or cubes, to be cut, this being illustrated in FIG. 3.

A press plunger, the groove pattern of which is configured in such a manner that said press plunger is usable for all three rotary alignments, can in particular be provided. A replacement of the press plunger is unnecessary in this way. Alternatively, a plurality of different press plungers can however also be used, wherein each press plunger is assigned to one of the rotary alignments.

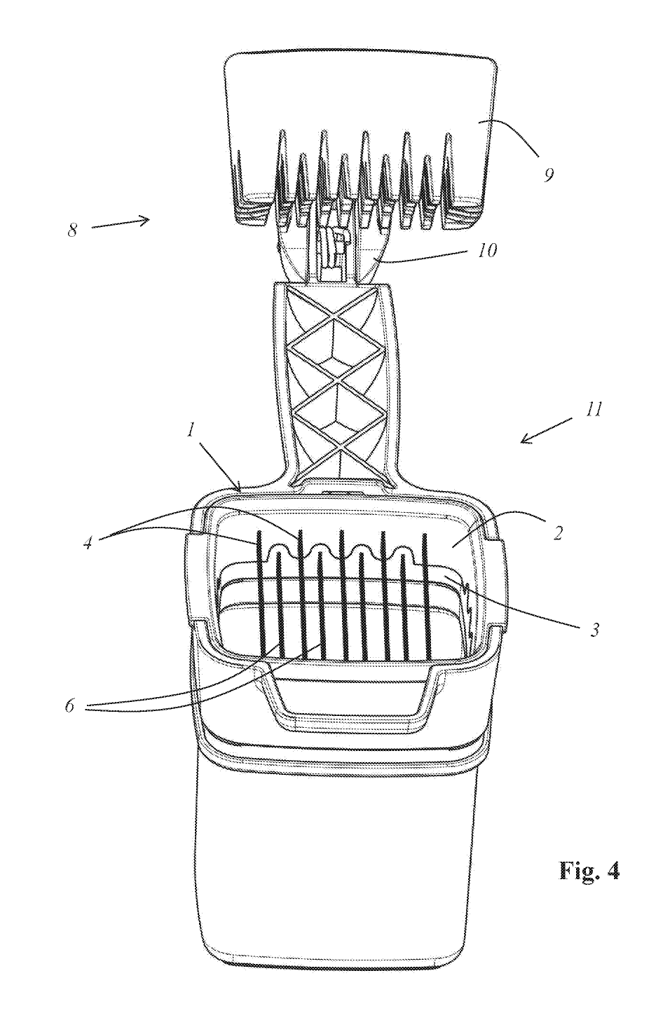

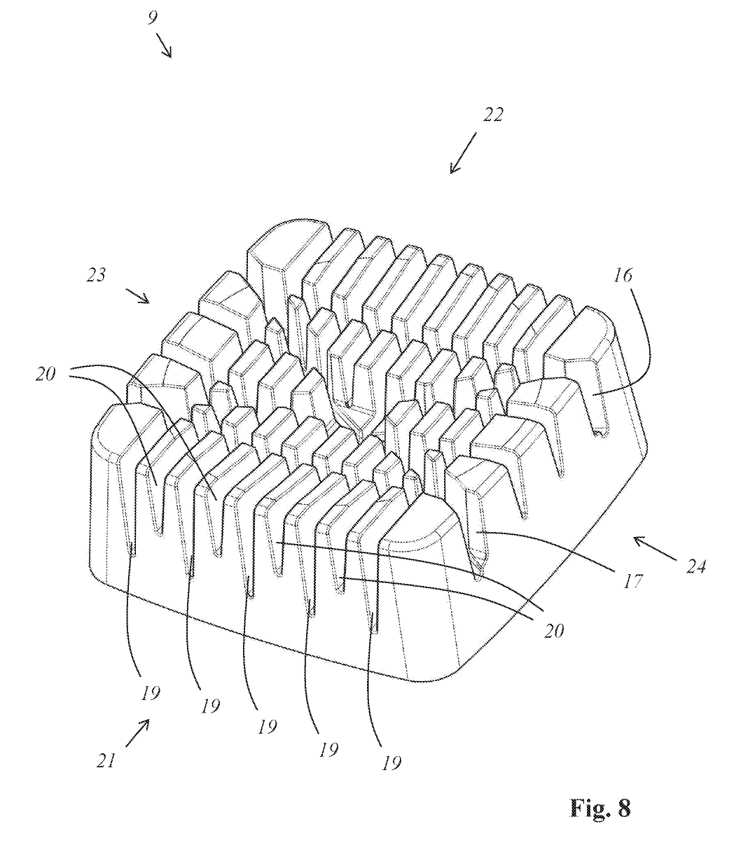

FIG. 4 shows an exemplary embodiment of a device for comminuting foodstuffs in the loading position, said device being configured as a hand-held apparatus. The device can in particular have the press plunger illustrated in FIGS. 8 to 11. The device has an actuation part 8 which has a press plunger 9. The press plunger 9 is fixedly attached to a press lever 10 of the actuation part 8. The device moreover has a base part 11 having a receptacle 1. The actuation part 8 is connected to the base part 11 in an articulated manner. The receptacle 1 is configured for receiving two cutting parts 2, 3 on top of one another such that product to be comminuted is advanceable through the cutting parts 2, 3 that are disposed on top of one another in the receptacle 1 by means of a pivoting movement of the actuation part 8 toward the base part 11, wherein the two cutting parts 2, 3 are disposable at different mutual relative rotary alignments in the receptacle 1.

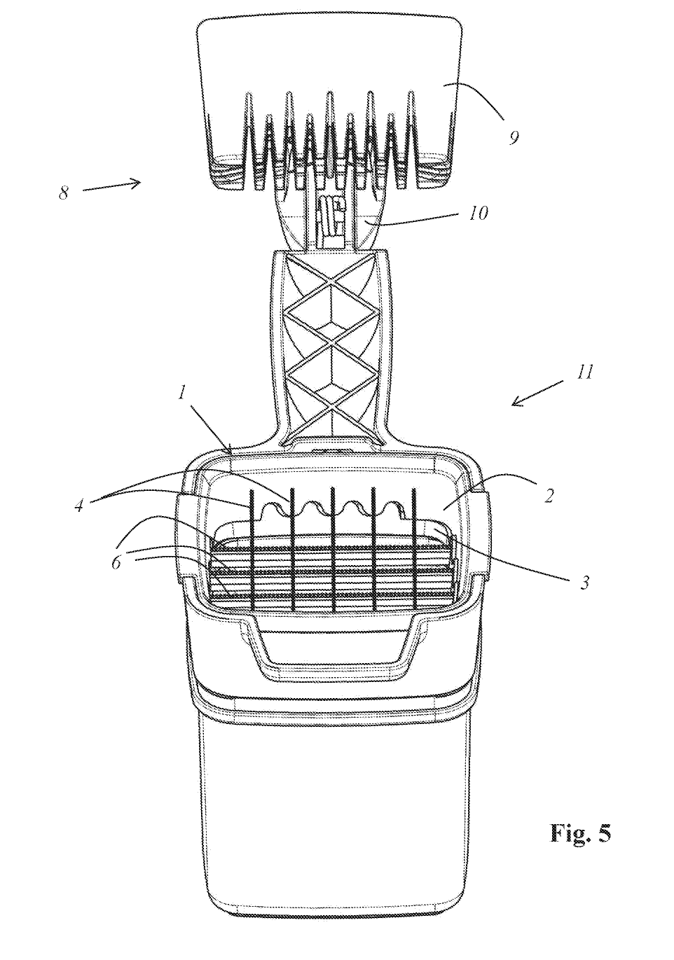

The actuation part 8 is pivoted toward the base part 11 in order for a foodstuff product to be comminuted. The foodstuff product that is pushed through the cutting parts 2, 3 automatically drops into the container 12. As the foodstuff product is pushed through the cutting parts 2, 3, the press plunger 9 comes to engage with the cutting parts 2, 3. In particular, the cutting blades 4, 6 of the cutting parts 2, 3 penetrate correspondingly assigned grooves and/or other grooves and/or further grooves of the press plunger 9. Another cut shape of the foodstuff product can be implemented in that the mutual rotary alignment of the cutting parts 2, 3 is modified, this being illustrated in FIG. 5.

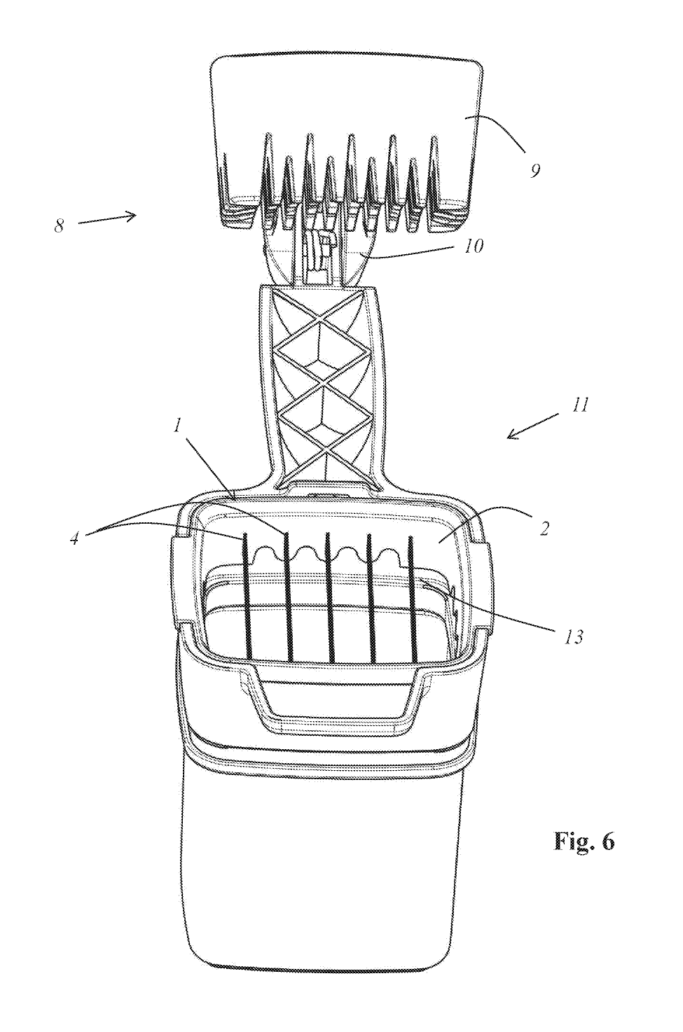

It is also possible for only one of the cutting parts 2, 3 and a placeholder frame 13 to be inserted into the receptacle 1, for example in order for wider slices to be cut. This is illustrated in FIG. 6.

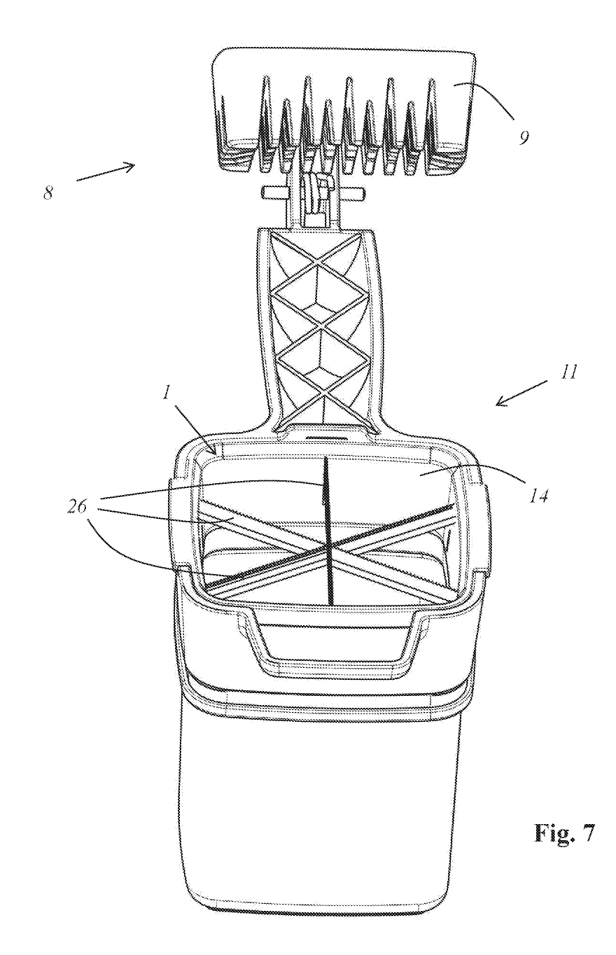

It is also possible for another cutting part 14 having another cutting-blade arrangement to be inserted into the receptacle 1 instead of the cutting parts 2, 3, for example in order for wedges to be cut. This is illustrated in FIG. 7. The other cutting-blade arrangement is formed by three cutting blades 26 which intersect in a crossing region 27.

In the case of this device a press plunger 9 is present, the groove pattern of said press plunger 9 being configured in such a manner that said press plunger 9 is usable for all three rotary alignments.

The press plunger 9 for a device according to the invention as illustrated in FIGS. 8 to 11 has a set of grooves having a plurality of, in particular precisely four, grooves 15. The four grooves 15 run so as to be mutually parallel. The press plunger moreover has another set of grooves having a first other groove 16, wherein the first other groove 16 intersects each of the grooves 1 in each case at an angle α1. The angle α1 is larger than 0° and smaller than 90°.

The other set of grooves moreover has a second other groove 17 which intersects each of the first grooves 15 at an angle α2. The angle α2 is larger than 0° and smaller than 90°. In the embodiment shown, the first other groove 16 intersects the grooves 15 at the same angle as the second other groove 17.

The first other groove 16 and the second other groove 17 mutually intersect in a crossing region 18. An angle β between the first other groove 16 and the second other groove 17 herein is larger than 0° and smaller than 90°. The grooves 15 of the set of grooves and the other grooves 16, 17 of the other set of grooves have a linear and continuous profile.

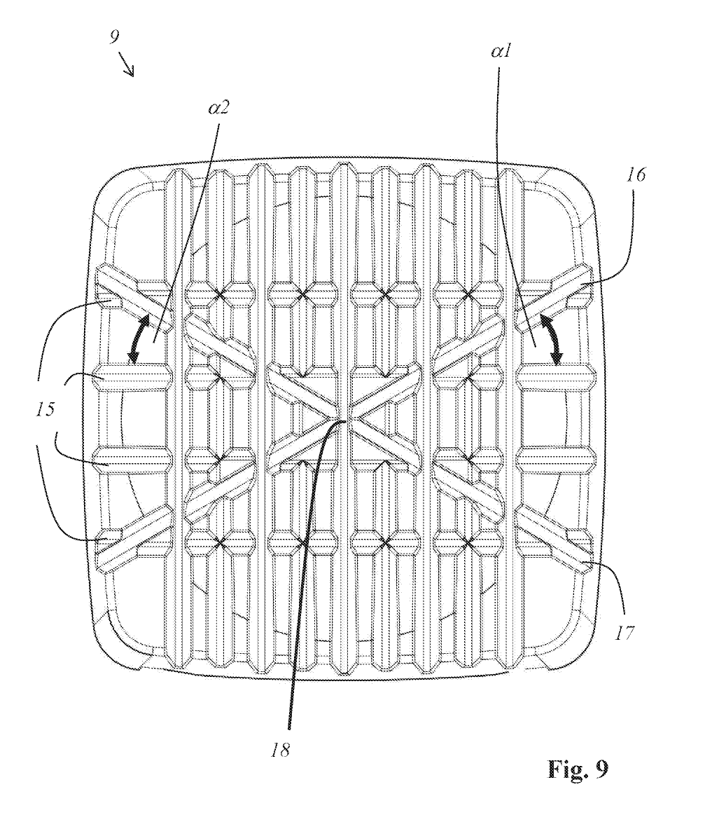

The press plunger 9 moreover has a further set of grooves which has a plurality of further grooves, in particular nine further grooves. The further grooves run so as to be mutually parallel and/or have a linear and continuous profile. As can be seen from FIG. 8, the further set of grooves herein has five first further grooves 19 and four second further grooves 20. The first further grooves 19 differ from the second further grooves 20 in that the former have a greater groove depth. Moreover, the first further grooves 19 and the second further grooves 20 intersect the grooves 15 of the set of grooves at an angle of 90°. Additionally, a first further groove 19 intersects the first other groove 16 and the second other groove 17 in the crossing region 18, as can be seen from FIG. 9.

The grooves 15 of the set of grooves are disposed in the press plunger 9 in such a manner that the further grooves 19, 20 of the further set of grooves extend from a first press-plunger peripheral side 21 to a second press-plunger peripheral side 22. The grooves 15 extend from a third press-plunger peripheral side 23 to a fourth press-plunger peripheral side 24. The first other groove 16 and the second other groove 17 likewise extend from the third press-plunger peripheral side 23 to the fourth press-plunger peripheral side 24.

The first press-plunger peripheral side 21 and the second press-plunger peripheral side 22 herein are mutually opposite in relation to a plane of one of the grooves 15. The third press-plunger peripheral side 23 and the fourth press-plunger peripheral side 24 are mutually opposite in relation to another plane of one of the first further grooves 19 or of one of the second further grooves 20.

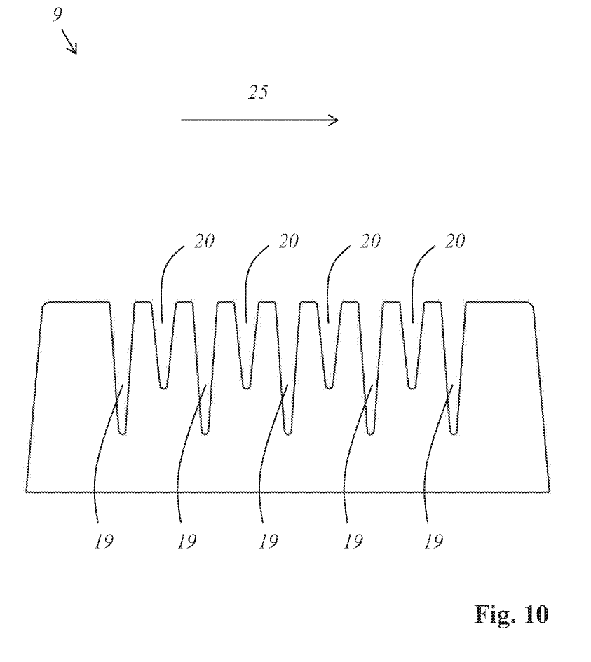

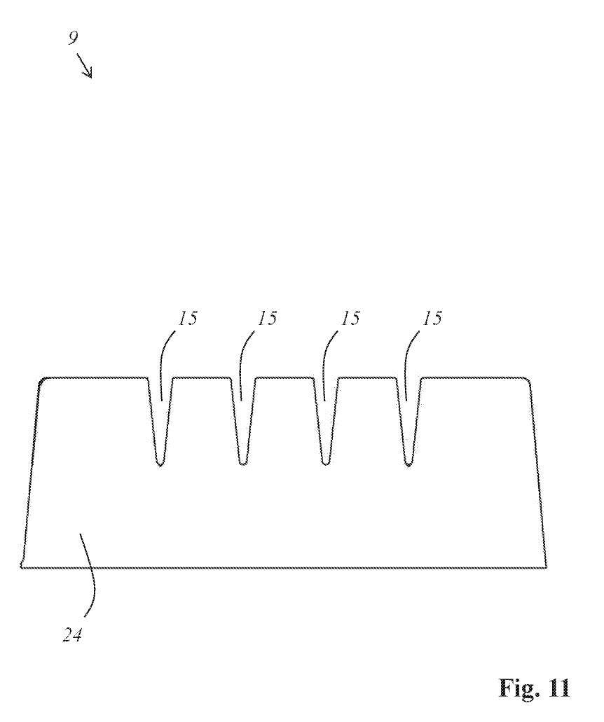

FIG. 11 shows a front view of the fourth press-plunger peripheral side 24. It can be seen from FIG. 11 that the grooves 15 of the set of grooves all have the same groove depth. A side view of the press plunger, in particular a view of the first press-plunger peripheral side 21, is shown in FIG. 10. As has already been described above, the first further grooves 19 have a greater groove depth than the second further grooves 20. It can moreover be derived from FIG. 10 that the first further grooves 19 and the second further grooves 20 are disposed in an alternating manner along the direction 25 from the third press-plunger peripheral side 23 to the fourth press-plunger peripheral side 24. The second further grooves 20 herein have the same groove depth as the grooves 15.

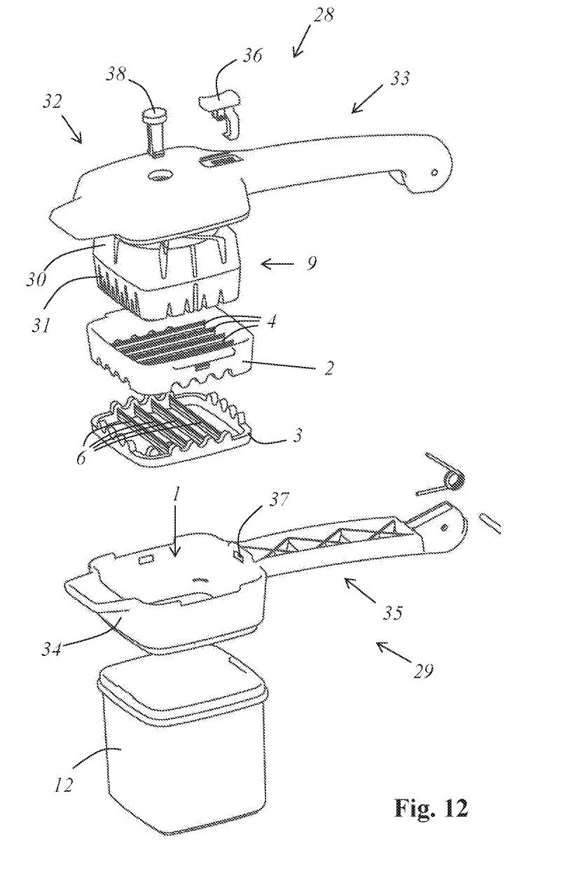

The hand-held apparatus shown in FIG. 12 is a further exemplary embodiment of a device according to the invention. Said hand-held apparatus has a first handgrip part 28 which has a press plunger 9 which is embodied as a double press plunger. The hand-held apparatus moreover has a second handgrip part 29 which includes a receptacle 1. The first handgrip part 28 is connected to the second handgrip part 29 in an articulated manner such that the first handgrip part 28 from the loading position to a closed position is pivotable toward the second handgrip part 29 in order for foodstuff product to be comminuted (not illustrated in the figures) to be pushed through cutting parts 2, 3 that are inserted into the receptacle 1. Once the foodstuff product has been pushed through the cutting parts 2, 3 the first handgrip part 28 is pivoted back from the closed position to the loading position. The press plunger 9 is attachable to the first handgrip part 28 so as to be releasable and/or so as to be detachable therefrom.

The press plunger 9 has a first plunger region 30 and a second plunger region 31. The press plunger 9 is attachable to the first handgrip part 28 selectively in a first operative position in which the foodstuff product that is to be comminuted is advanceable through the cutting parts 2, 3 by means of the first plunger region 30, or in a second operative position in which the foodstuffs product that is to be comminuted is advanceable through the cutting parts 2, 3 by means of the second plunger region 31.

The first handgrip part 28 has a press-plunger portion 32 and a first handgrip portion 33. The press-plunger portion 32 has a press-plunger receptacle for partially receiving the press plunger 9.

The second handgrip part 29 has a cutting-part portion 34 and a second handgrip portion 35. The cutting-part portion 34 has the receptacle 1. The hand-held apparatus moreover has a container 12 onto which the cutting-part portion 34 can be placed. The container 12 is completely covered by the cutting-part portion 34 when the cutting-part portion 34 is placed onto the container 12.

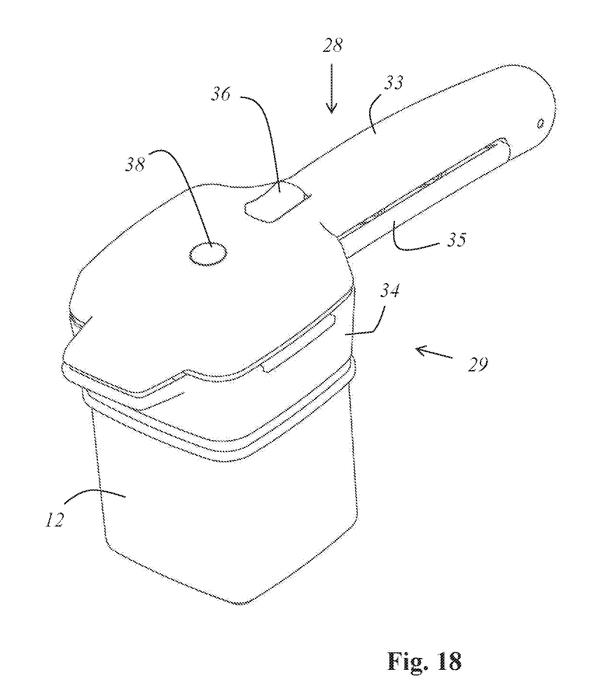

The hand-held apparatus moreover has a latching device which has a latching element 36 that is provided on the first handgrip part 28 and a counter-latching element 37 that is provided on the second handgrip part 29. In a closed position of the hand-held apparatus the first handgrip part 28 bears completely on the second handgrip part 29, wherein by activating the latching element 36 the latter can be connected to the counter-latching element 37 in such a manner that the first handgrip part 28 and the second handgrip part 29 can be held in the closed position which is illustrated in FIG. 18. The connection between the latching element 36 and the counter-latching element 37 can be released again by activating the latching element 36 again.

The hand-held apparatus moreover has a holding means 38 which for securing the press plunger 9 to the press-plunger portion 32 is operatively connected to a counter-holding means of the press plunger 9. The counter-holding means is a conduit that extends through both plunger regions 30, 31. The holding means 38 has two hook-shaped protrusions which are configured so as to be movable in relation to one another. A force which causes the protrusions to move in relation to one another is exerted by the user of the hand-held apparatus on both protrusions in order for the press plunger 9 to be released from the press-plunger portion 32.

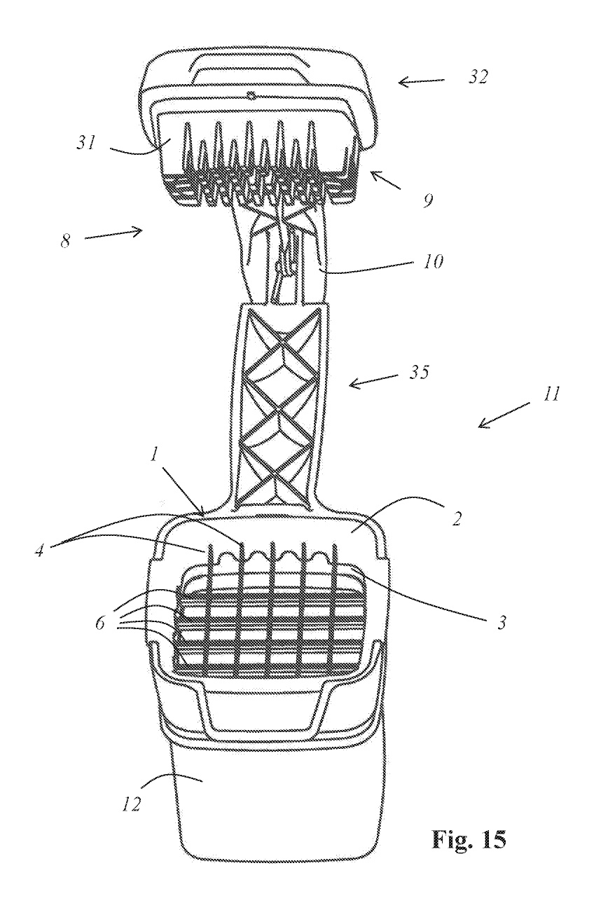

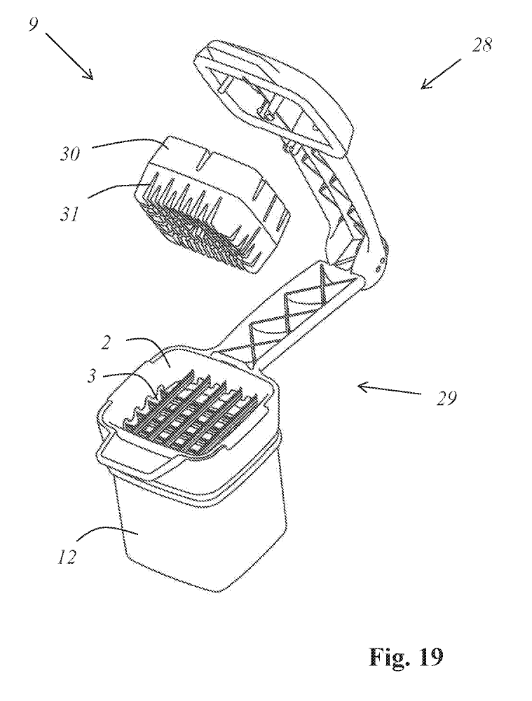

The cutting parts 2, 3 can be inserted into the receptacle in such a manner, for example, that the first cutting blades 4 of the first cutting part 2 and the second cutting blades 6 of the second cutting part 3 when viewed in the projection intersect and thus form a cutting-blade arrangement for cutting sticks or cubes, this being illustrated in FIGS. 12, 15, and 19.

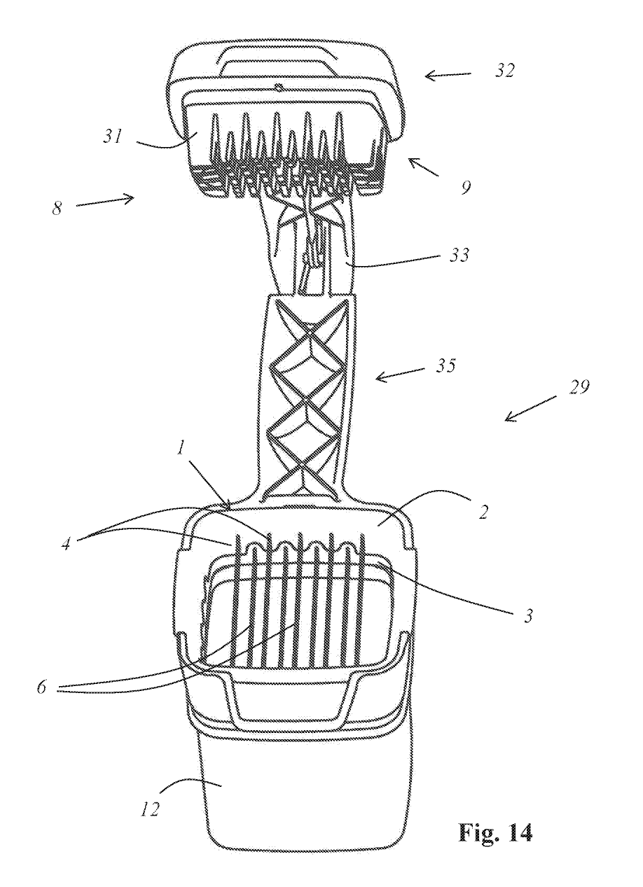

It is also possible for the cutting parts 2, 3 to be inserted into the receptacle in such a manner that the first cutting blades 4 of the first cutting part 2 and the second cutting blades 6 of the second cutting part 3 are disposed so as to be mutually parallel and thus form a cutting-blade arrangement for cutting thin slices, this being illustrated in FIG. 14.

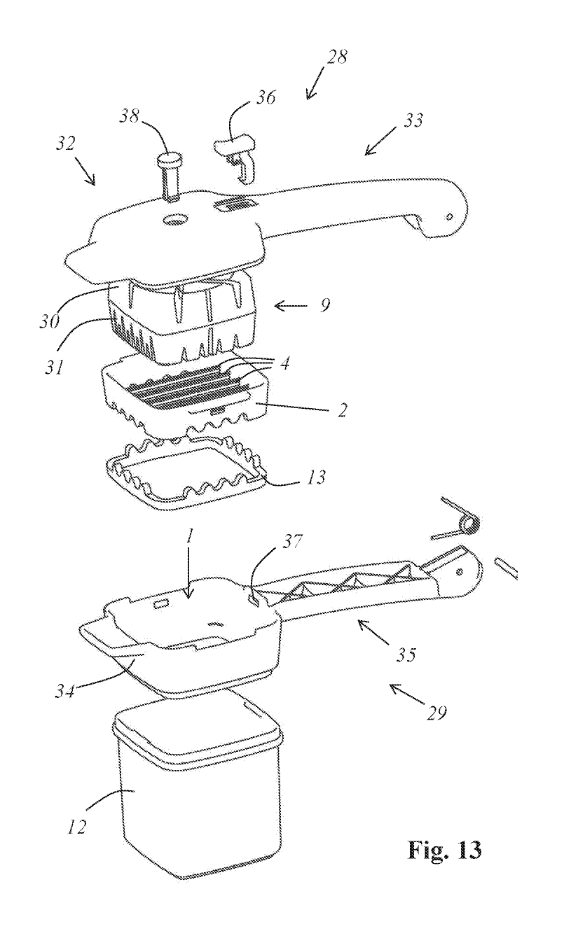

It is also possible to insert only one of the cutting parts 2, 3 and a placeholder frame 13 into the receptacle 1, for example in order to cut wider slices. This is illustrated in FIG. 13.

The second plunger region 31 of the press plunger is used both for cutting sticks or cubes as well as for cutting slices.

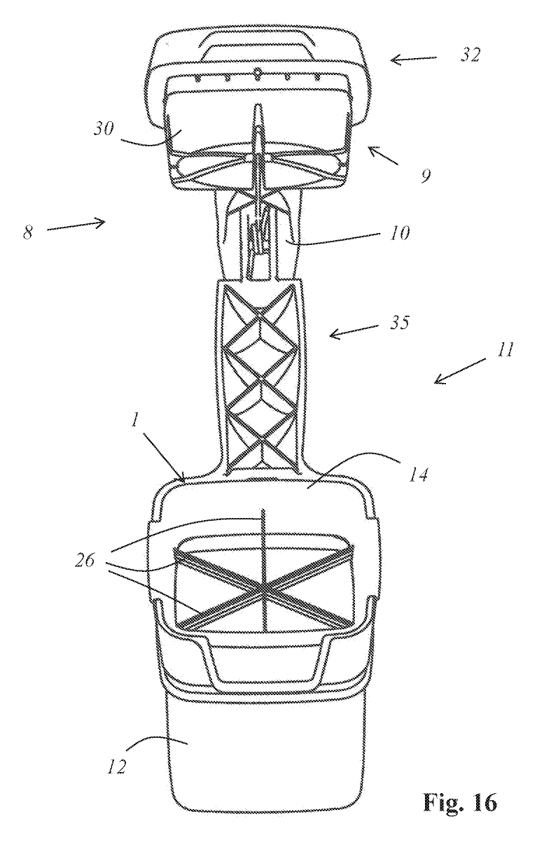

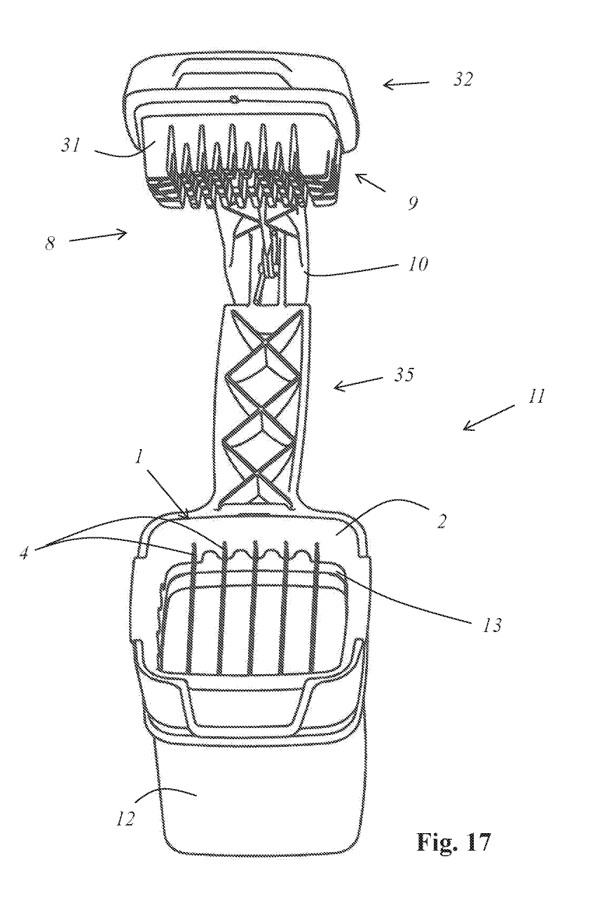

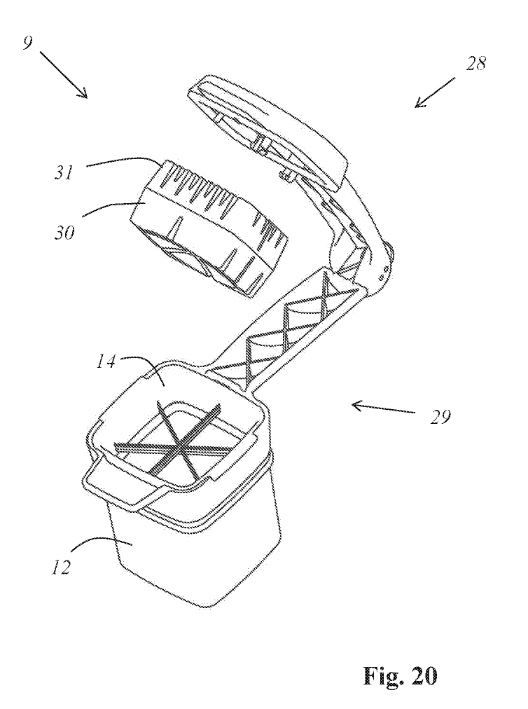

It is also possible for another cutting part 14 having another cutting-blade arrangement to be inserted into the receptacle 1 instead of the cutting parts 2, 3, for example in order for wedges to be cut. This is illustrated in FIGS. 16 and 20. The other cutting-blade arrangement is formed by three cutting blades 26 which intersect in a crossing region 27. The first plunger region 30 of the press plunger is used for cutting wedges.

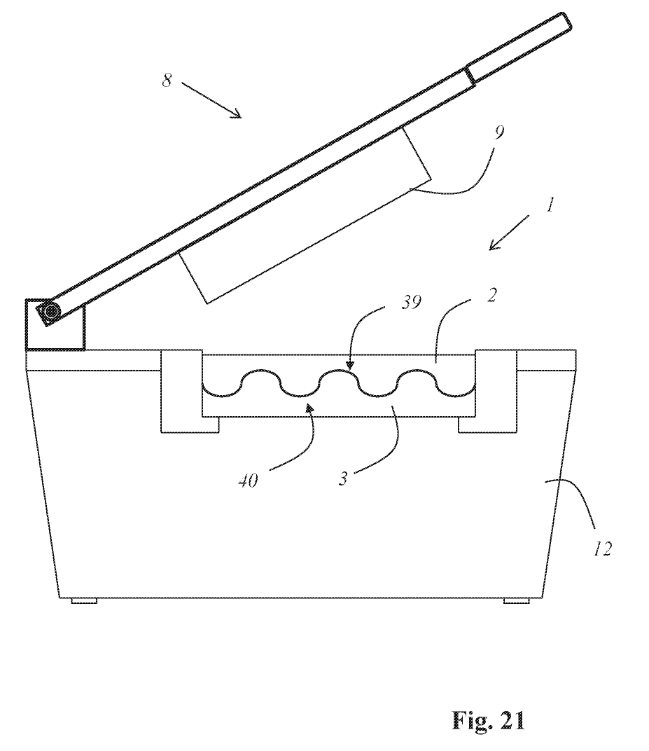

FIG. 21 shows an exemplary embodiment of a device according to the invention, configured as a table-top apparatus, for comminuting foodstuffs. The device has a container 12 which functions as a stand for setting up on a worktop. A lid-type attachment of the base part that is placed onto the container 12 has a receptacle 1 for a plurality of cutting parts 2, 3 which can be disposed on top of one another in the receptacle. An actuation part having a press plunger 9 is disposed in an articulated manner on the base part. The cutting part 2 has a toothing 39 which interacts with a counter-toothing 40 of the second cutting part 3 so as to fix the cutting parts 2, 3 in a mutually relative manner.

1. A device for comminuting foodstuffs, having a base part which has a receptacle for a cutting part, and having an actuation part that is connected in an articulated manner to the base part and is pivotable toward the base part in order for a product to be comminuted to be pushed along a pushing through direction through a cutting part that is inserted into the receptacle, wherein a plurality of cutting parts are present and wherein the receptacle is configured for receiving at least two cutting parts on top of one another such that product to be comminuted by means of a pivoting movement of the actuation part toward the base part is capable of being pushed through the cutting parts that are disposed on top of one another in the receptacle, wherein the two cutting parts are disposable at different mutual relative rotary alignments in the receptacle.

2. The device as claimed in claim 1, wherein
a. the cutting parts are stackable on top of one another in such a manner that the cutting planes of the blades of the stacked cutting parts are disposed so as to be mutually parallel, and/or wherein
b. the cutting parts are stackable on top of one another in such a manner that the cutting planes of the blades of the stacked cutting parts are disposed so as to be mutually spaced apart, and/or wherein
c. the cutting parts are stackable on top of one another in such a manner that the cutting parts in terms of their mutual relative alignment, in particular in terms of their mutual rotary alignment, are fixed so as to be perpendicular to the pushing through direction.

3. The device as claimed in claim 1, wherein the cutting parts have identical external dimensions or wherein the cutting parts in a plane that is perpendicular to the pushing through direction have identical external dimensions.

4. The device as claimed in claim 1, wherein
a. at least one cutting part has a coupling means which is configured and specified for being operatively connected, in particular in a form-fitting manner, to a counter-coupling means of another cutting part, and/or wherein
b. at least one cutting part has both a coupling means which is configured and specified for being operatively connected, in particular in a form-fitting manner, to a counter-coupling means of another cutting part, as well as a counter-coupling means which is configured and specified for being operatively connected to a coupling means of another cutting part.

5. The device as claimed in claim 4, wherein the coupling means is configured as a toothing or has a toothing, and/or wherein the counter-coupling means is configured as a counter-toothing or has a counter-toothing.

6. The device as claimed in claim 1, wherein
a. the cutting parts in each case have one blade holder to which at least one cutting blade is fastened in particular so as not to be releasable in a non-destructive manner, and/or wherein
b. a blade holder without a cutting blade, in particular a placeholder frame, which in combination with at least one cutting part is insertable into the receptacle is present.

7. The device as claimed in claim 5, wherein the blade holder comprises the coupling means and/or the counter-coupling means.

8. The device as claimed in claim 7, wherein the blade holder as the coupling means has a toothing that is aligned counter to the pushing through direction, and/or the blade holder as the counter-coupling means has a counter-toothing that is aligned in the pushing through direction.

9. The device as claimed in claim 6, wherein the blade holder is configured as a frame which in a cutting-blade plane of the cutting part surrounds at least one cutting blade.

10. The device as claimed in claim 6, wherein the blade holders of the cutting parts are of identical configuration, or wherein the blade holders of the cutting parts have identical dimensions in the cutting plane and/or in a plane that is perpendicular to the pushing through direction.

11. The device as claimed in claim 6, wherein the blade holders are configured so as to be square, and/or wherein the blade holders comprise a rotational symmetry.

12. The device as claimed in claim 1, wherein two cutting parts are disposable in the receptacle so as to selectively have at least a first mutual relative rotary alignment or so as to have a second mutual relative rotary alignment, wherein the first rotary alignment differs from the second rotary alignment by a rotation angle of 45 degrees or of 90 degrees.

13. The device as claimed in claim 1, wherein at least two of the cutting parts have different cutting-blade arrangements.

14. The device as claimed in claim 1, wherein a first cutting part has mutually parallel first cutting blades, and wherein a second cutting part has mutually parallel second cutting blades.

15. The device as claimed in claim 14, wherein
a. the first cutting part and the second cutting part are disposable on top of one another in the receptacle in such a manner that the first cutting blades and the second cutting blades are disposed so as to be mutually parallel, or wherein
b. the first cutting part and the second cutting part are disposable on top of one another in the receptacle in such a manner that the first cutting blades and the second cutting blades are disposed so as to be mutually parallel but so as to be mutually offset in a projection along the pushing through direction.

16. The device as claimed in claim 14, wherein the first cutting part and the second cutting part are disposable on top of one another in the receptacle in such a manner that the first cutting blades and the second cutting blades in a projection along the pushing through direction are disposed in a mutually cruciform manner, and/or in a projection along the pushing through direction are mutually orthogonal.

17. The device as claimed in claim 1, wherein the actuation part has a press plunger.

18. The device as claimed in claim 17, wherein the press plunger has grooves into which the cutting blades of the cutting parts that are inserted into the receptacle plunge in a comminution procedure.

19. The device as claimed in claim 17, wherein the press plunger is disposed on a press lever of the actuation part so as to be non-releasable, in particular not releasable in a non-destructive manner.

20. The device as claimed in claim 17, wherein the press plunger is secured or is securable on a press lever of the actuation part so as to be releasable, in particular so as to be releasable in a non-destructive manner, and/or without tools.

21. The device as claimed in claim 20, wherein the press plunger is configured as a double press plunger which has two, in particular different, individual press plungers and which is secured or securable selectively in a first operative position or in a second operative position on a press lever of the actuation part.

22. The device as claimed in claim 21, wherein the press plunger is transferable from the first operative position to the second operative position by rotating the press plunger relative to the press lever, in particular by 180 degrees.

23. The device as claimed in claim 17, wherein the same press plunger is configured to be used with different cutting parts that are inserted into the receptacle, and/or wherein the same press plunger is configured to be used with different combinations of cutting parts that are inserted into the receptacle

24. The device as claimed in claim 17, wherein the same press plunger is configured to be used with a plurality of cutting parts that are disposed on top of one another in the receptacle, independently of the mutual rotary alignment of the cutting parts that are disposed on top of one another in the receptacle.

25. The device as claimed in claim 17, wherein the press plunger includes a set of grooves which has at least two grooves that run mutually parallel and another set of grooves comprising a first other groove, wherein the first other groove intersects the at least two grooves in each case at an angle that is more than 0 degrees and less than 90 degrees.

26. The device as claimed in claim 25, wherein the other set of grooves has a second other groove, wherein the first other groove and the second other groove mutually intersect in a crossing region.

27. The device as claimed in claim 25, wherein
a. the first other groove and the second other groove mutually intersect at an angle unequal to 90°, and/or wherein
b. the second other groove intersects the grooves of the first set of grooves at an angle which in each case is more than 0° and less than 90 degrees.

28. The device as claimed in claim 25, characterized by a further set of grooves which comprises at least two further grooves which
a. run so as to be mutually parallel, and/or
b. intersect the first grooves at an angle of 90 degrees, and/or wherein
c. a further groove of the further grooves intersects the first other groove and the second other groove in the crossing region.

29. The device as claimed in claim 25, wherein
a. the further set of grooves comprises at least one first further groove and at least one second further groove which have a groove depth that is dissimilar to the first further groove, and/or wherein
b. the other grooves of the other set of grooves have the same groove depth, and/or wherein
c. the grooves of the set of grooves have the same groove depth.

30. The device as claimed in claim 25, wherein the press plunger can be brought to engage with a cutting part having one cutting-blade arrangement, and be brought to engage with another cutting part having another cutting-blade arrangement in which at least three cutting blades mutually intersect in a crossing region.

31. The device as claimed in claim 25, wherein
a. the further grooves of the further set of grooves extend from a first press plunger side to a second press plunger side, and/or wherein
b. the first other groove of the other set of grooves and/or the second other groove of the other set of grooves and/or the grooves of the set of grooves extends from a third press plunger side to a fourth press plunger side.

32. The device as claimed in claim 20, wherein at least one further press plunger which is securable as a replacement for the press plunger on the press lever is present.

33. The device as claimed in claim 20, wherein
a. the press plunger is configured to be used with a plurality of specific cutting parts that are disposed on top of one another in the receptacle, while the further press plunger is configured to be used with a plurality of other cutting parts that are disposed on top of one another in the receptacle, or wherein
b. the press plunger is configured to be used with a plurality of specific cutting parts that are disposed on top of one another in the receptacle and which have a specific mutual rotary alignment, while the further press plunger is configured to be used with the same cutting parts that are disposed on top of one another in the receptacle when the latter have another mutual rotary alignment.

34. The device as claimed in claim 1, wherein the base part is placed or is placeable on a container for the comminuted product, or wherein the base part has a container for the comminuted product.

35. The device as claimed in claim 1, wherein the device is configured as a hand-held apparatus.

36. The device as claimed in claim 35, wherein the base part has a first handgrip part and the actuation part has a second handgrip part, both handgrip parts being able to be collectively gripped with the fingers of one hand and being disposed so as to be able to be mutually compressed in particular in the manner of pliers.

37. The device as claimed in claim 36, wherein the first handgrip part protrudes laterally beyond the container.

38. The device as claimed in claim 1, wherein the device is configured as a table-top apparatus, and/or wherein the device for a comminution procedure is configured and specified to be set up on a worktop, and/or wherein the device has a stand for setting up on a worktop.

39. The device as claimed in claim 38, wherein the stand is formed by a container for the comminuted product.
